(19) United States
(12) Patent Application Publication
(10) Pub. No.: US 2015/0075865 A1
(43) Pub. Date: Mar. 19, 2015

(54) Electric Wire Holding Structure

(71) Applicant: Yazaki Corporation, Minato-ku, Tokyo (JP)

(72) Inventor: Shingo Chiba, Makinohara-shi (JP)

(73) Assignee: Yazaki Corporation, Minato-ku, Tokyo (JP)

(21) Appl. No.: 14/387,324

(22) PCT Filed: Mar. 21, 2013
(86) PCT No.: PCT/JP2013/059160

§ 371 Date: Sep. 23, 2014

(30) Foreign Application Priority Data
Mar. 23, 2012 (JP) 2012-067130

(51) Int. Cl. H01R 4/24; H01R 9/24

(52) U.S. Cl. CPC H01R 4/24; H01R 9/24
USPC 174/84 R

(57) ABSTRACT

A connector connecting structure includes an electric wire holder in which part of a plurality of electric wires are aligned and held and that has a rotation shaft at one end of the electric wire holder in a direction perpendicular to an extending direction of the part of the plurality of electric wires held in the electric wire holder and an electric wire holder attached portion that includes a plurality of press contacting terminals to which the plurality of electric wires are press contacted and to which the electric wire holder is attached while the rotation shaft of the electric wire holder is supported by a shaft supporting portion and the electric wire holder is rotated.

### TECHNICAL FIELD

The present invention relates to an electric wire holding structure in which a plurality of electric wires are press contacted to press contact terminals to be held.

### BACKGROUND ART

Traditionally, an electric wire holding structure, in which a plurality of electric wires are press contacted to press contacting terminals to be held, includes an electric wire holder in which part of the plurality of electric wires are aligned and held, and an electric wire holder attached portion which is provided with the press contacting terminals to which the electric wires are press contacted, and to which the electric wire holder is attached. When the electric wire holder is attached to the electric wire holder attached portion, the plurality of electric wires are press contacted to the press contacting terminals and held in the electric wire holding structure. For example, in a PTL 1, an electric wire holding structure is disclosed which can reduce the load necessary for press contaction even if a plurality of electric wires are press contacted to press contacting terminals at the same time (for example, refer to the PTL 1).

The electric wire holding structure described in the PTL 1 has an electric wire holder, in which part of the plurality of electric wires are aligned and held and which has rotation shafts at one end side in a direction perpendicular to the extending direction of the plurality of electric wires, and an electric wire attached portion, which are provided with a shaft supporting portion which pivotally supports the rotation shafts and the plurality of press contacting terminals to which the electric wires are press contacted, and to which the electric wire holder is attached while the electric wire holder is pivotally supported by the shaft supporting portion and is rotated. When the electric wire holder is attached to the electric wire holder attached portion, the plurality of electric wires are press contacted to the press contacting terminals, and are held.

### CITATION LIST

### Patent Literature

PTL 1
   JP-A-2011-113802

### SUMMARY OF INVENTION

### Technical Problem

However, in the electric wire holding structure described in the PTL 1, because the electric wire holder is held so that the derived parts of the plurality of electric wires are kept away from the electric wire holder attached portion, the holding force of the electric wire holder becomes weak, the electric wire holder gets loose, and, as a result, the connection stability of the electric wires and the press contacting terminals might decrease.

The present invention is made in view of the above situation, and the object of the present invention is to provide an electric wire holding structure so that while the load necessary when a plurality of electric wires are press contacted to press contacting terminals is lowered, the connection stability of the electric wires and the press contacting terminals can be prevented from decreasing.

### Solution to Problem

(1) According to an aspect of the invention, a connector connecting structure includes an electric wire holder in which part of a plurality of electric wires are aligned and held and that has a rotation shaft at one end of the electric wire holder in a direction perpendicular to an extending direction of the part of the plurality of electric wires held in the electric wire holder and an electric wire holder attached portion that includes a plurality of press contacting terminals to which the plurality of electric wires are press contacted and to which the electric wire holder is attached while the rotation shaft of the electric wire holder is supported by a shaft supporting portion and the electric wire holder is rotated. The plurality of electric wires are held by being press contacted to the press contacting terminals when the electric wire holder is attached to the electric wire holder attached portion. The electric wire holder attached portion includes a pair of electric wire holder holding walls which hold the electric wire holder by being abutted with the electric wires so that the electric wires are bent upwards at both side positions of the electric wire holder, and laterally sandwiching parts of the plurality of electric wires that are bent upwards and the electric wire holder when the electric wire holder is attached to the electric wire holder attached portion while the electric wire holder is rotated.

(2) In the electric wire holding structure of (1), a shape of a cross section of the rotation shaft is a semi-circular shape when the rotation shaft is cut along a plane perpendicular to a rotation axis of the rotation shaft. The shaft supporting portions have a shaft receiving groove to which the rotation shaft is insertable from above. The shaft receiving groove includes a narrow groove portion whose width is set so that the rotation shaft is insertable in a state where a straight line portion of the semi-circular sections of the rotation shaft faces an edge of the groove and a wide groove portion whose width is enlarged with respect to the width of the narrow groove portion so that a stepped face portion are horizontally formed at a lower end of the narrow groove portion and the rotation shaft is rotateable at a bottom of the shaft receiving groove so that the straight line portion face upwards. The stepped face portion is abutted with a face forming the straight line portion of the rotation shaft when the electric wire holder is moved upwards during the rotation of the rotation shaft at the bottom of the shaft receiving groove.

In the electric wire holding structure of (1), while the electric wire holder is pivotally supported by the shaft supporting portion and is rotated, the plurality of electric wires are press contacted to the press contacting terminals. Further, the strain relief structure is applied, the pair of electric wire holder holding walls laterally sandwich the parts of the plurality of electric wires that are bent upwards and the electric wire holder, and the electric wire holder is held so that a wobble of the electric wire holder is prevented. Therefore, while the load necessary when the plurality of electric wires are press contacted to the press contacting terminals is lowered, the connection stability of the electric wires and the press contacting terminals can be prevented from decreasing.

In the electric wire holding structure of (2), during the rotation of the electric wire holder, when the electric wires contact the pair of electric wire holder holding walls and the electric wire holder is moved upwards due to the reaction force, the surfaces forming the straight line portions of the rotation shafts are abutted with the stepped surfaces, and the electric wire holder is rotated while the stepped surfaces become fulcrums in the principle of leverage. Therefore, even when the electric wire holder is rotated in a state that the plurality of electric wires are located between the pair of electric wire holder holding walls, it is possible to reduce the load necessary for the rotation.

### BRIEF DESCRIPTION OF DRAWINGS

FIG. 1 is an exploded perspective view of a lighting device in which an electric wire holding structure according to an embodiment of the present invention is incorporated.

FIG. 2 is a perspective view of the lighting device before an electric wire holder shown in FIG. 1 is attached.

FIG. 3 is an enlarged figure of an area around an electric wire holder attached portion shown in FIG. 2.

FIG. 4 is a top view of an area around the electric wire holder attached portion shown in FIG. 3.

FIG. 5 is an enlarged figure of the electric wire holder shown in FIG. 1.

FIG. 6 is a perspective view which shows a state before an upper holding portion of the electric wire holder shown in FIG. 1 is overlaid on a lower holding portion of the electric wire holder.

FIG. 7 is a top view which shows a state that the electric wire holder is attached to the electric wire holder attached portion shown in FIG. 4.

FIG. 8 is a side view of the electric wire holder and the electric wire holder attached portion shown in FIG. 7.

FIG. 9 is an A-A line sectional view of the electric wire holder and the electric wire holder attached portion shown in FIG. 7.

FIG. 10 is a B-B line sectional view of the electric wire holder and the electric wire holder attached portion shown in FIG. 7.

FIGS. 11A-11C are figures which show steps of setting four electric wires to the electric wire holder.

FIGS. 12A and 12B include figures which show steps of attaching the electric wire holder to the electric wire holder attached portion.

FIGS. 13A and 13B include figures which show steps of attaching the electric wire holder to the electric wire holder attached portion.

FIG. 14 is an A-A line sectional view of the electric wire holder and the electric wire holder attached portion shown in FIG. 7, and is a figure for describing a state before the electric wires are abutted with a pair of electric wire holder holding walls.

FIG. 15 is an A-A line sectional view of the electric wire holder and the electric wire holder attached portion shown in FIG. 7, and is a figure for describing a state after the electric wire holder has been attached to the electric wire holder attached portion.

### DESCRIPTION OF EMBODIMENTS

Below, an embodiment of the electric wire holding structure according to the present invention is described in detail with reference to the figures.

### Embodiment

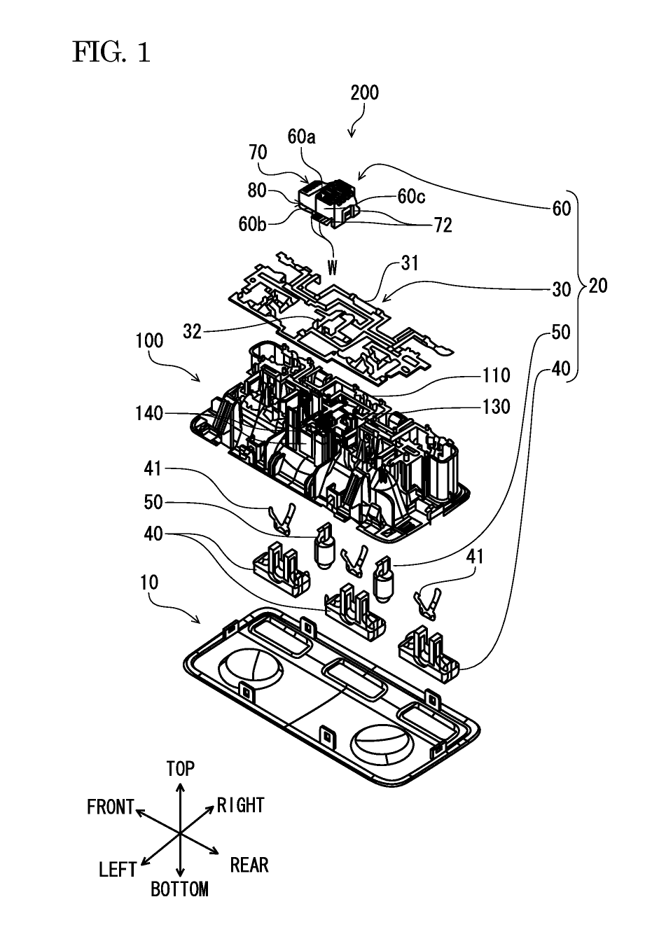

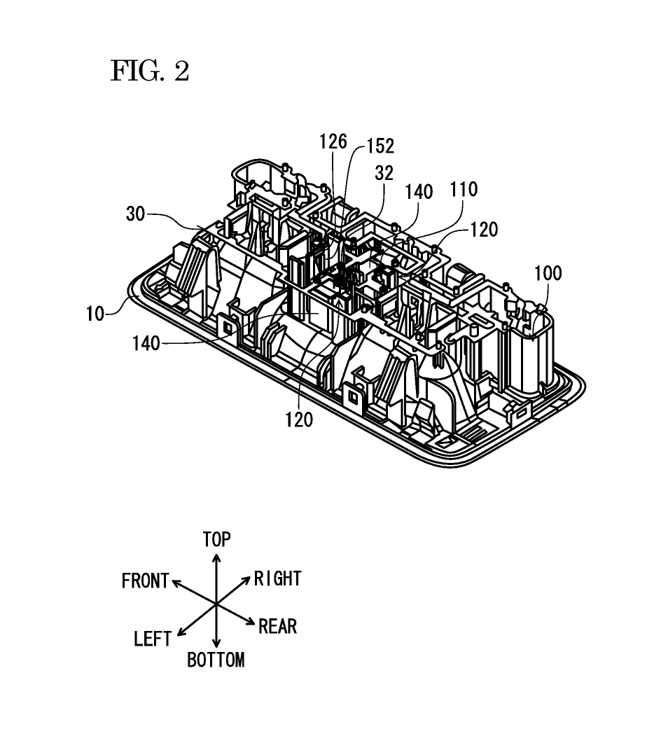

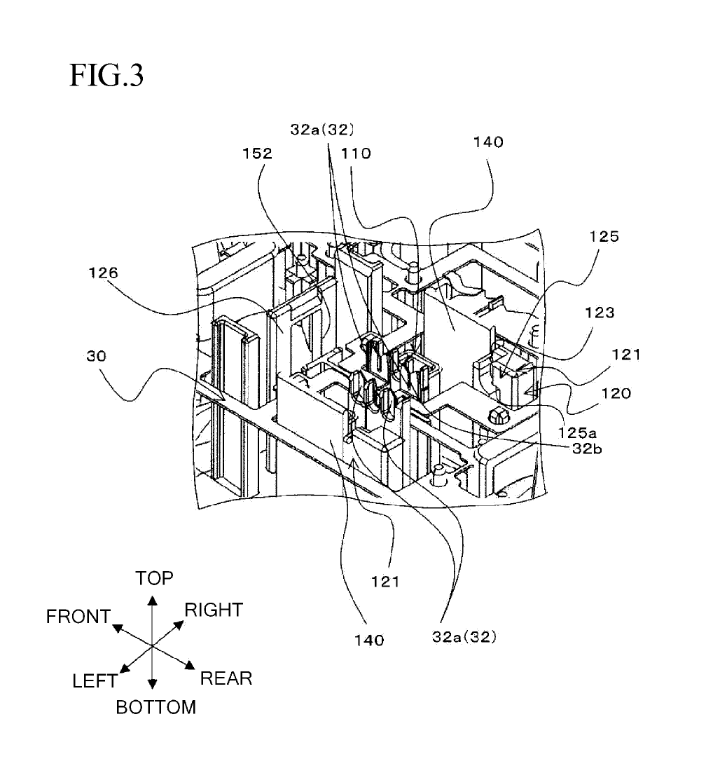

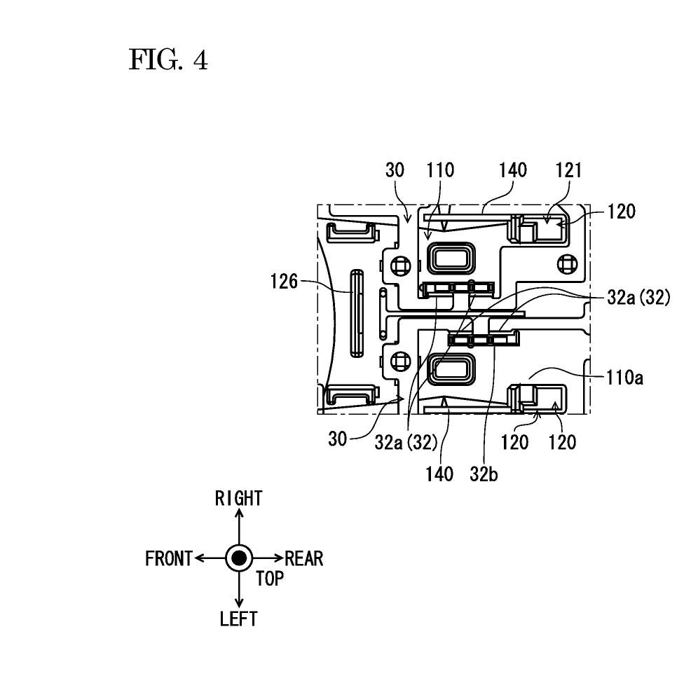

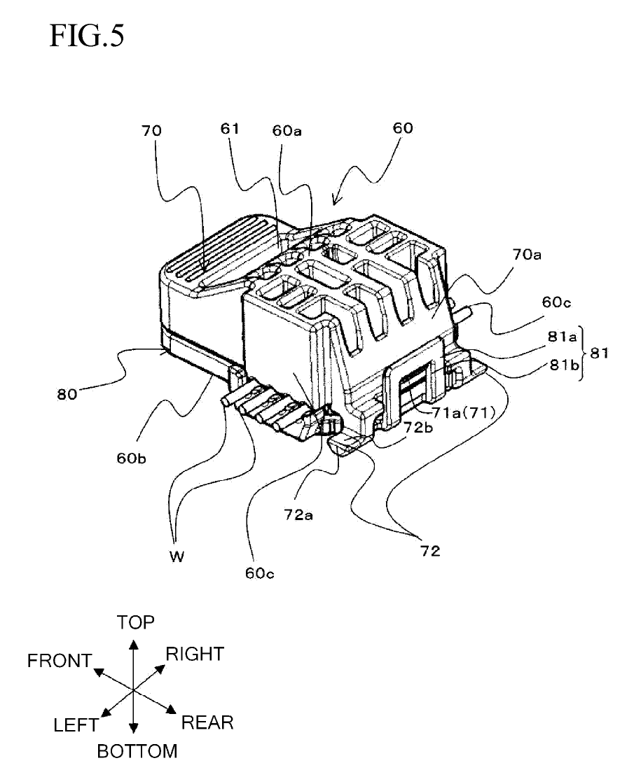

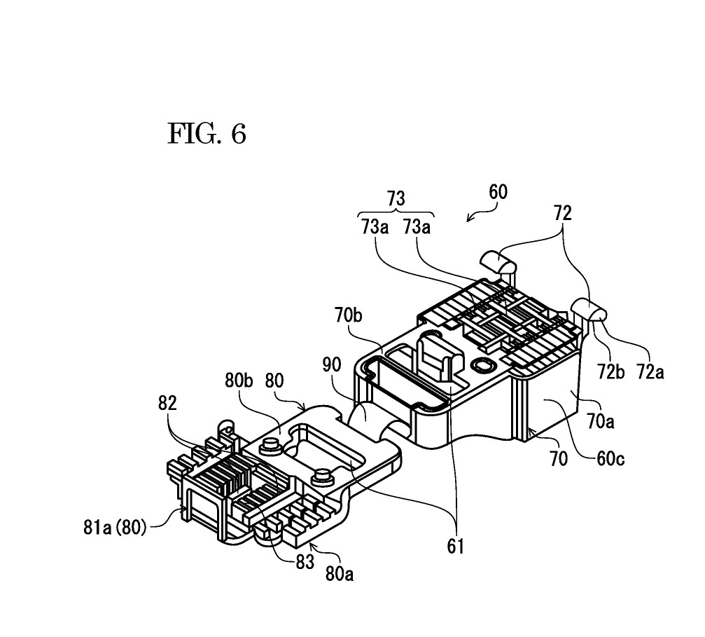

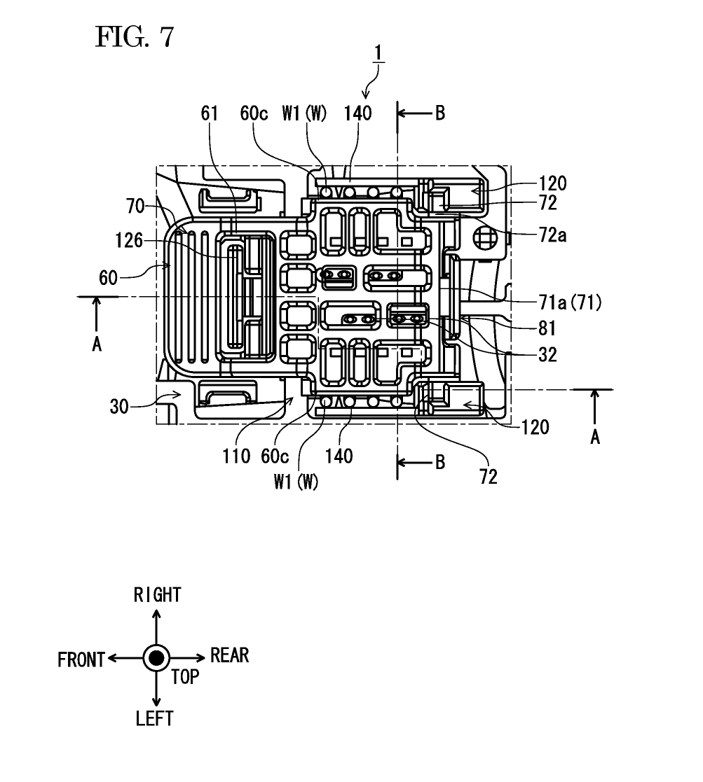

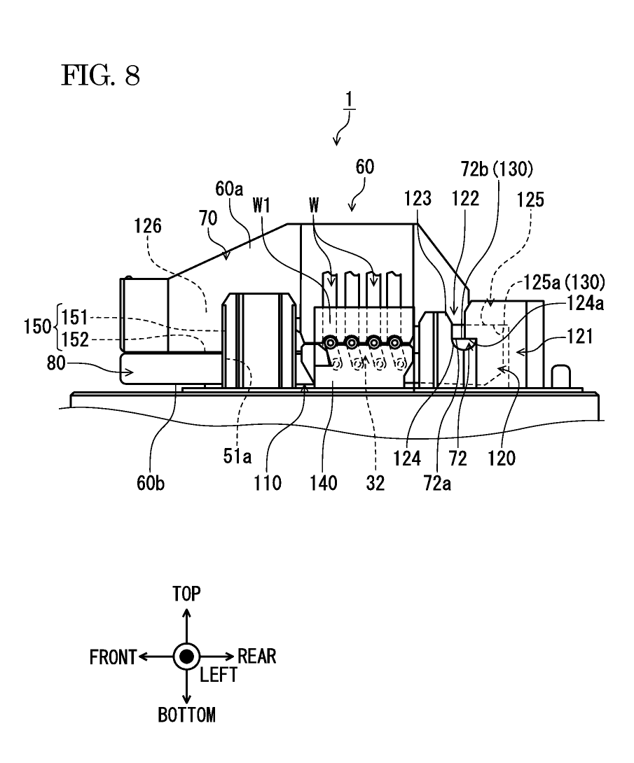

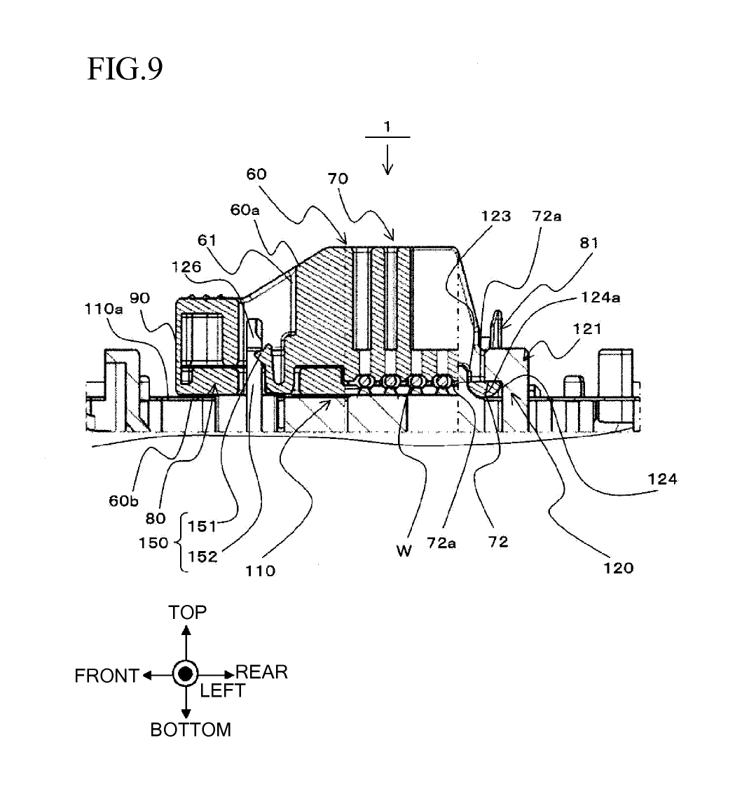

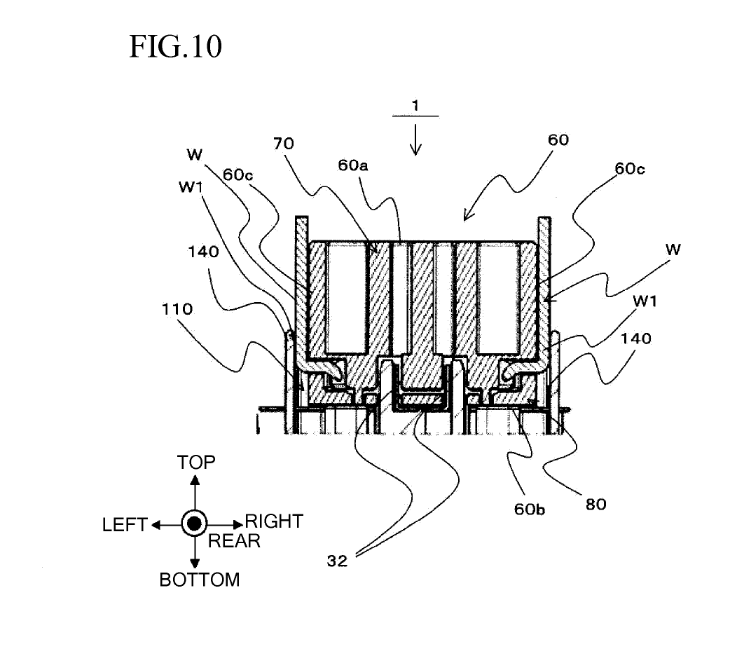

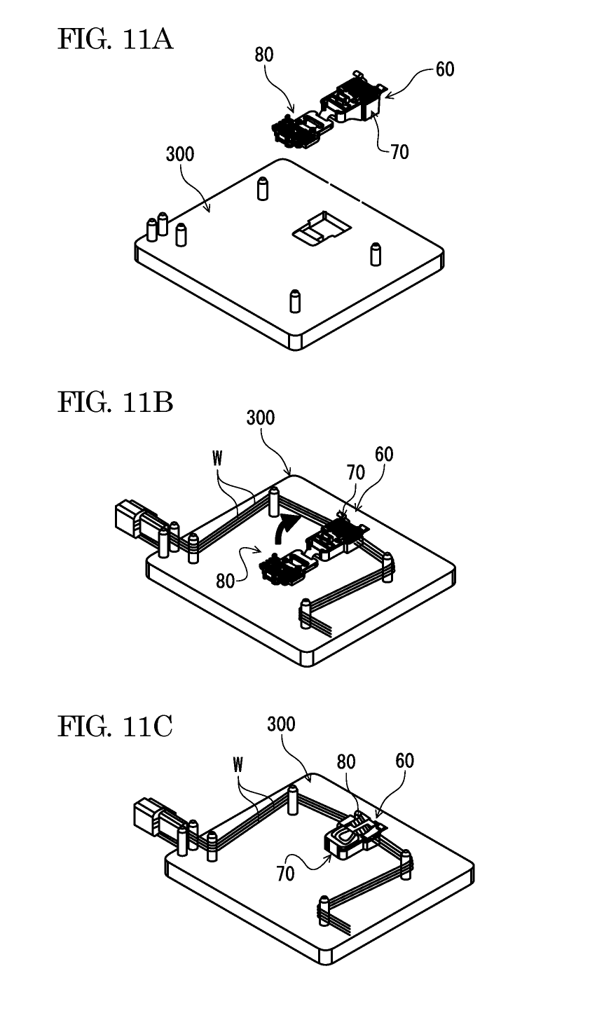

FIG. 1 is an exploded perspective view of a lighting device in which an electric wire holding structure 1 according to an embodiment of the present invention is incorporated. FIG. 2 is a perspective view of the lighting device 200 before an electric wire holder 60 shown in FIG. 1 is attached. FIG. 3 is an enlarged figure of an area around an electric wire holder attached portion 110 shown in FIG. 2. FIG. 4 is a top view of an area around the electric wire holder attached portion 110 shown in FIG. 3. FIG. 5 is an enlarged figure of the electric wire holder 60 shown in FIG. 1. FIG. 6 is a perspective view which shows a state before an upper holding portion 70 of the electric wire holder 60 shown in FIG. 1 is overlaid on a lower holding portion 80 of the electric wire holder 60. FIG. 7 is a top view which shows a state that the electric wire holder 60 is attached to the electric wire holder attached portion 110 shown in FIG. 4. FIG. 8 is a side view of the electric wire holder 60 and the electric wire holder attached portion 110 shown in FIG. 7. FIG. 9 is an A-A line sectional view of the electric wire holder 60 and the electric wire holder attached portion 110 shown in FIG. 7. FIG. 10 is a B-B line sectional view of the electric wire holder 60 and the electric wire holder attached portion 110 shown in FIG. 7. FIGS. 11A-11C includes figures which show steps of setting four electric wires W to the electric wire holder 60.

For convenience, the directions of arrows in the figures are assumed as forwards/backwards, right-to-left/left-to-right, and upwards/downwards directions.

The electric wire holding structure 1 according to the embodiment of the present invention has the electric wire holder 60 and the electric wire holder attached portion 110. Part of the four electric wires W are aligned and held in the electric wire holder 60, and the electric wire holder 60 has rotation shafts 72 at one end in the direction perpendicular to the extending direction of the four electric wires W. The electric wire holder attached portion 110 is provided with a plurality of press contacting terminals 32 to which the four electric wires W are press contacted, respectively. The electric wire holder 60 is attached to the electric wire holder attached portion 110 while the rotation shafts 72 of the electric wire holder 60 are pivotally supported by shaft supporting portions 120 and the electric wire holder is rotated. When the electric wire holder 60 is attached to the electric wire holder attached portion 110, the electric wire holder 60 and the electric wire holder attached portion 110 are engaged with an engaging portion 150, and the four electric wires W are press contacted to the press contacting terminals 32 and are held.

For example, such an electric wire holding structure 1 is incorporated in the lighting device 200 arranged on the indoor ceiling of a vehicle.

The lighting device 200 has a lens 10, a lighting function portion 20, and a housing 100.

First, the lens 10 is described.

The external shape of the lens 10 is a rectangle, and the lens 10 collects light emitted from bulbs 50 which is the source of the light.

Next, the lighting function portion 20 is described.

The lighting function portion 20 has a bus bar 30, a switch operation portion 40, the bulbs 50 and the electric wire holder 60.

The bus bar 30 is a wiring member which is made by forging a conductive metal plate-like member to a circuit shape. The bus bar 30 is attached to the housing 100 using welding pins or the like not shown in the figure.

The bus bar 30 has a power supply terminal 31 and four press contacting terminals 32 to which the four electric wires W are press contacted. As shown in FIGS. 3 and 4, each of the press contacting terminals 32 has a press contacting blade 32a in which a groove 32b is formed. When the electric wires W are pushed into the grooves 32b of the press contacting blades 32a, insulative coating parts (not shown in the figure) of the electric wires W are torn off, and exposed conductor parts are connected to the press contacting blades 32a.

In this embodiment, it is exemplified that the number of the electric wires W is four, but the number of the electric wires W is not limited to four. The number of the press contacting terminals 32 is also not limited, and is set according to the number of the electric wires W.

The switch operation portion 40 is an operation portion that changes operation modes (ON/FF) of the bulbs 50, and is attached to the housing 100. Contacts 41 that are terminals are incorporated in the switch operation portion 40, and when the contacts 41 are connected to the power supply terminal 31, an operation of supplying power to the bulbs 50 is performed in accordance with an operation mode of the switch operation portion 40.

Part of the four electric wires W are aligned and held in the electric wire holder 60, and when the electric wire holder 60 is attached to the electric wire holder attached portion 110 while being rotated, the four electric wires W are press contacted to the press contacting terminals 32 at the same time.

As shown in FIGS. 5 and 6, in the electric wire holder 60, an upper holding portion 70 forming a holder top surface 60a of the electric wire holder 60 and a lower holding portion 80 forming a holder bottom surface 60b of the electric wire holder 60 are connected through a joint 90 which can be bent. The electric wire holder 60 is so formed that when the joint 90 is bent, the lower holding portion 80 is overlaid on the upper holding portion 70, and the four electric wires W are sandwiched between the upper holding portion 70 and the lower holding portion 80.

The upper holding portion 70 has an upper holding side engaging portion 71, the rotation shafts 72, and an upper holding side electric wire receiving portion 73.

The upper holding side engaging portion 71 is a portion which is engaged with a lower holding side engaging portion 81 to be described below when the upper holding portion 70 is overlaid on the lower holding portion 80. The upper holding side engaging portion 71 has an convex engaging portion 71a which is projected from an end 70a at the side where the joint 90 is not provided among the ends of the upper holding portion 70 in the direction the electric wires W are paralleled.

The rotation shafts 72 are projected from two side parts near the end 70a at the side where the joint is not provided among the ends of the upper holding portion 70 in the direction the electric wires W are paralleled. The rotation shafts 72 have a columnar shape which has a semi-circular cross section.

The upper holding side electric wire receiving portion 73 is a portion where the part of the four electric wires W are aligned and held, and has four electric wire receiving grooves 73a in which the electric wires W are embedded.

The lower holding portion 80 has the lower holding side engaging portion 81, a press contacting blade penetrated portion 82, and a lower holding side electric wire receiving portion 83.

The lower holding side engaging portion 81 is a portion which is engaged with the upper holding portion side engaging portion 71 when the upper holding portion 70 is overlaid on the lower holding portion 80. The lower holding side engaging portion 81 has an engaging strip 81a which has a strip form and is raised from a surface 80b on which the upper holding portion 70 is overlaid at the position of an end 80a where the joint 90 is not provided among the ends of the lower holding portion 80 in the direction the electric wires W are paralleled, and an engaging hole 81b which is a through hole formed in the engaging strip 81a.

The press contacting blade penetrated portion 82 has through holes which are formed in the lower holding portion 80 so that the press contacting blades 32a can penetrate through the lower holding portion 80.

The lower holding side electric wire receiving portion 83 is a portion which maintains the four electric wires W in an aligned state and pushes the electric wires W into the electric wire receiving grooves 73a of the upper holding portion 70 when the upper holding portion 70 is overlaid on the lower holding portion 80 so that the four electric wires W are sandwiched between the upper holding portion 70 and the lower holding portion 80.

A through hole 61 for engagement, which is formed to pass through an engaging wall 126 to be described below, is formed, and when an convex engaging portion 151 which the electric wire holder 60 is provided with in the through hole 61 for engagement and an engaging hole portion 152 which the electric wire holder attached portion 110 is provided with are engaged, the electric wire holder 60 is fixed to the electric wire holder attached portion 110.

When the four electric wires W are set in the electric wire holder 60, as shown in FIGS. 11A-11C, a jig for supporting setting electric wires 300 which fixes the electric wire holder 60 and adjusts the position and tension of each of the electric wires W is used. An operator sets the electric wire holder 60 on the jig for supporting setting electric wires 300 (FIG. 11A), arranges the electric wires W into the entries of the electric wire receiving grooves 73a of the upper holding portion 70 (FIG. 11B), and bends the joint 90 so that the upper holding portion 70 is overlaid on the lower holding portion 80 (FIG. 11C). Thereby, the four electric wires W are set in the electric wire holder 60.

Next, the housing 100 is described.

The housing 100, to which the lens 10 and the lighting function portion 20 are attached, is a base of the lighting device 200.

The housing 100 has the electric wire holder attached portion to which the electric wire holder 60 is attached.

The electric wire holder attached portion 110 is a portion which is provided with four press contacting terminals 32 to which the four electric wires W are press contacted, respectively, and to which the electric wire holder 60 is attached while the rotation shafts of the electric wire holder 60 are pivotally supported by the shaft supporting portions 120 and the electric wire holder is rotated. When the electric wire holder 60 is attached to the electric wire holder attached portion 110, the four electric wires W are press contacted to the press contacting terminals 32, and are held.

The shaft supporting portion 120 has shaft receiving walls 121 including walls which are raised from an attached surface 110a to which the electric wire holder 60 is attached, shaft receiving grooves 122 including grooves which are formed so that the rotation shafts 72 are insertable from above, shaft falling preventing and abutting surfaces 130 against which the electric wire holder 60 abuts to regulate the upwards movement of the electric wire holder 60, and which prevent the rotation shafts 72 from falling from the shaft receiving grooves 122, and an engaging wall 126 which is raised from the attaching surface 110a to which the electric wire holder 60 is attached, and in which the engaging hole portion 152 to be described below is formed.

As shown in FIG. 8, the shaft receiving groove 121 has a narrow groove portion 123 and a wide groove portion 124 so that the width of the groove changes from a narrow part to a wide part from the entry side of the groove towards the inside of the groove.

The narrow groove portion 123 is a portion in which the width of the groove is about the radius of the rotation shafts which have a columnar shape whose cross section is semi-circular. With such a narrow groove portion 123, the rotation shaft 72 is adapted to be inserted in a state where a straight line portion 72a of the semi-circular section shape faces the inside edge of the groove.

The wide groove portion 124 is a portion in which the width of the groove is enlarged until the terminal part of the groove so that a horizontal stepped surface 124a is formed at the lower end of the narrow groove portion 123. With such a wide groove portion 124, the rotation shaft 72 is adapted to be rotated at the terminal part of the groove to such a direction that the straight line portion 72a of the semi-circular section shape faces upwards.

The shaft falling preventing and abutting surface 130 has an undersurface 125a of an upper protruding wall 125 and the stepped surface 124a of the shaft receiving groove 122.

The upper protruding wall 125 is a wall which is provided to be protruded above the holder top surface 60a of the electric wire holder 60, and is so formed that the undersurface 125a of the upper protruding wall 125 is abutted with the holder top surface 60a when the electric wire holder 60 is moved upwards from the attached position.

The stepped surface 124a of the shaft receiving groove 122 is adapted to abut with a surface 72b forming the straight line portion 72a of the rotation shaft 72 when the electric wire holder 60 is moved upwards.

The electric wire holder attached portion 110 has a pair of electric wire holder holding walls 140 which hold the electric wire holder 60.

The pair of electric wire holder holding walls 140 hold the electric wire holder 60 by being abutted with the electric wires W so that the electric wires W are bent upwards at two side parts 60c of the electric wire holder 60, and sandwiching bended parts W1 of the four electric wires W that are bent upwards and the electric wire holder 60 laterally, when the electric wire holder 60 is attached to the electric wire holder attached portion 110 while being rotated.

Each of the electric wire holder holding walls 140 has a rectangular external shape, and as shown in FIG. 8, the width of the electric wire holder holding walls 140 in the forwards/backwards direction is set so that the parts of the electric wires W that are hold by the electric wire holder 60 are received in the surfaces of the electric wire holder holding walls 140 when the electric wire holder 60 has been attached to the electric wire holder attached portion 110.

The height of the electric wire holder holding walls 140 is set so that the upper ends of the electric wire holder holding walls 140 are located above the parts of the electric wires W that are hold by the electric wire holder 60 when the electric wire holder 60 has been attached to the electric wire holder attached portion 110.

The electric wire holder holding walls 140 are set so that the distance between the electric wire holder holding walls 140 and the side parts 60c of the electric wire holder 60 generally equals to the diameter of the electric wires W as shown in FIG. 10.

Next, the engaging portion 150 is described.

With respect to the engaging portion 150, the electric wire holder 60 and the electric wire holder attached portion 110 are engaged at the attached position of the electric wire holder 60 with the convex engaging portion 151 which the electric wire holder 60 is provided with and the engaging hole portion 152 which the electric wire holder attached portion 110 is provided with.

The convex engaging portion 151 is a portion which is projected from an elastic engaging strip 151a. The elastic engaging strip 151a is projected into a strip shape from the hole border of the through hole 61 for engagement and the overlaid surface 70b of the upper holding portion 70, and is bent into a U shape in the through hole 61 for engagement.

The engaging hole portion 152 is formed so that engaging wall 126 is penetrated horizontally.

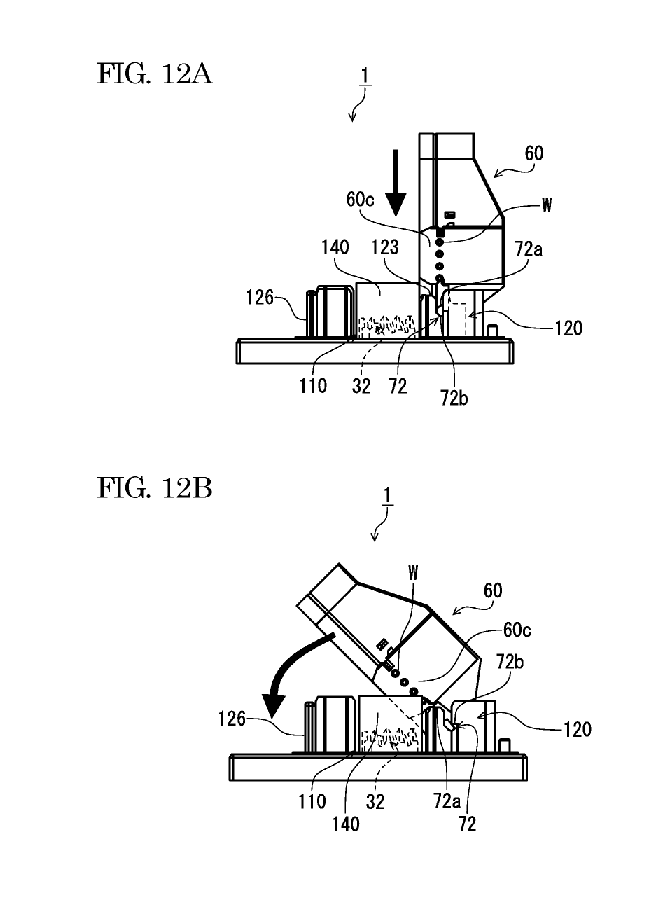

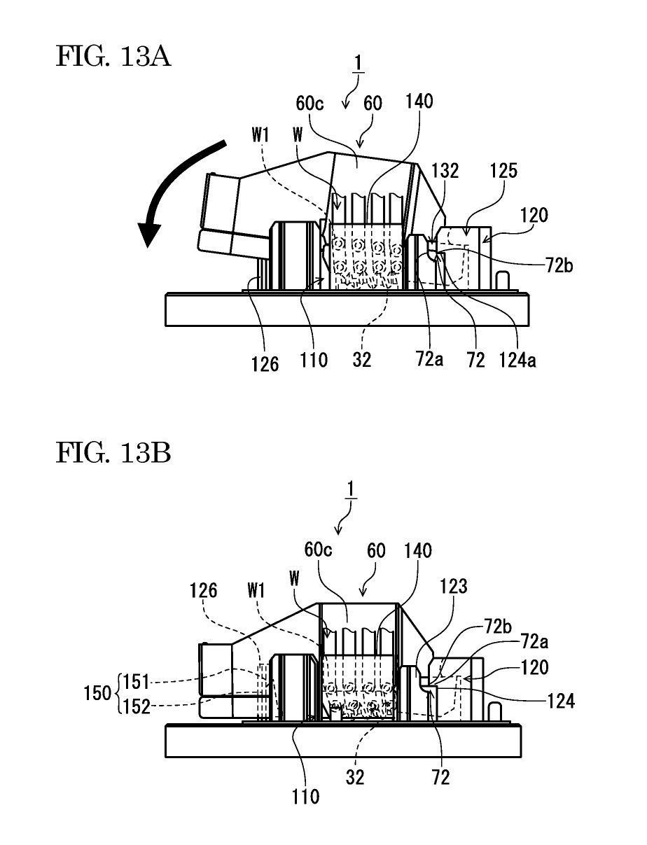

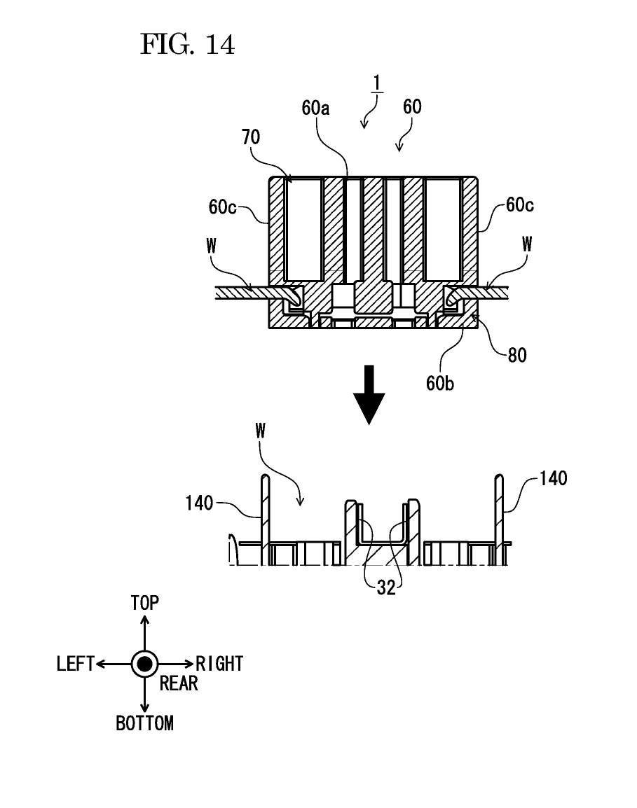

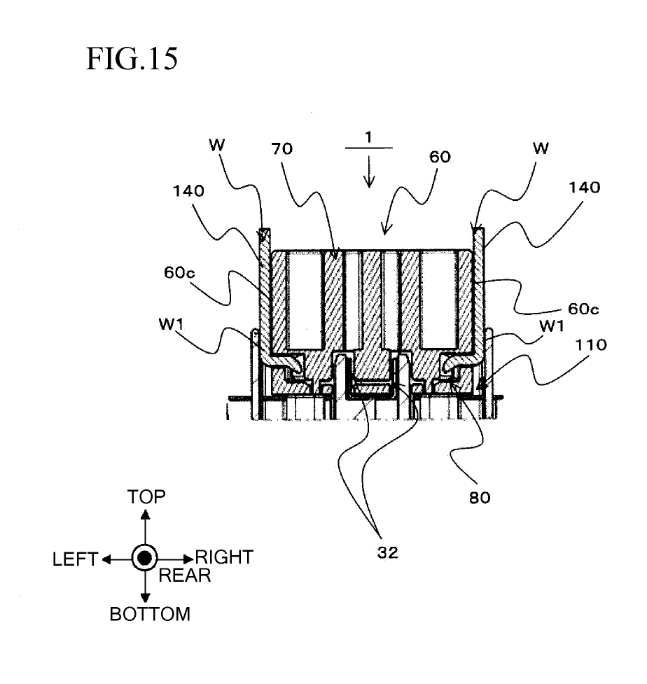

Steps of attaching the electric wire holder 60 to the electric wire holder attached portion 110 is described by using FIGS. 12 to 15. FIGS. 12A-13B are figures which show the steps of attaching the electric wire holder 60 to the electric wire holder attached portion 110. FIG. 14 is an A-A line sectional view of the electric wire holder 60 and the electric wire holder attached portion 110 shown in FIG. 7, and is a figure for describing a state before the electric wires W are abutted against the pair of electric wire holder holding walls 140. FIG. 15 is an A-A line sectional view of the electric wire holder 60 and the electric wire holder attached portion 110 shown in FIG. 7, and is a figure for describing a state after the electric wire holder 60 has been attached to the electric wire holder attached portion 110.

First, an operator attaches the rotation shafts 72 of the electric wire holder 60 to the shaft supporting portions 120 (refer to FIG. 12A). In this state, the electric wires W that are derived from the electric wire holder 60 are not bent, as shown in FIG. 14. When the rotation shafts 72 are inserted from the entries of the shaft receiving grooves 122 to be attached to the shaft supporting portions 120, the rotation shafts 72 are inserted in a state where the straight line portions 72a faces the inner edges of the grooves. Therefore, the direction of the electric wire holder 60 is decided, and a false assembly of the electric wire holder 60 is prevented.

Then, the operator makes the electric wire holder 60 rotate around the rotation shafts 72 (refer to FIG. 12B). At this time, while the electric wire holder 60 is rotated, the four electric wires W are brought close to the press contacting blades 32a. The electric wire holder 60 is rotated so that the four electric wires W derived from the two side parts 60c of the electric wire holder 60 start to be abutted with the pair of electric wire holder holding walls 140, and the electric wires W are bent upwards.

During the rotation of the electric wire holder 60, when the electric wires W contact the pair of electric wire holder holding walls 140, due to a reaction force from the pair of electric wire holder holding walls 140, the electric wire holder 60 is moved upwards, and the surfaces 72b of the rotation shafts 72 are abutted with the stepped surfaces 124a. In this case, the electric wire holder 60 is rotated while the stepped surfaces 124a become fulcrums in the principle of leverage.

Then, when the operator makes the electric wire holder 60 further rotate, the electric wires W start to be press contacted to the press contacting terminals 32 (refer to FIG. 13A). At this time, when the electric wires W contact the press contacting blades 32a, due to a reaction force of the force with which the electric wires W are to be cut, the electric wire holder 60 is moved upwards, and the surfaces 72b of the rotation shafts 72 are abutted with the stepped surfaces 124a. Therefore, the electric wires W can be close to press contacting blades 32a and can be easily press contacted since the stepped surfaces 124a become fulcrums in the principle of leverage.

Then, the operator makes the electric wire holder 60 further rotate, and when the electric wire holder 60 and the electric wire holder attached portion 110 are engaged with the engaging portion 150, the attaching of the electric wire holder 60 to the electric wire holder attached portion 110 is completed (refer to FIG. 13B). When the electric wire holder 60 has been attached to the electric wire holder attached portion 110, the electric wire holder 60 is held from the sides of the two side parts 60c by the pair of electric wire holder holding walls 140 together with the electric wires W that are bent upwards, as shown in FIG. 15. Further, the electric wire holder 60 is held in a state that the electric wires W derived from the two side parts 60c of the electric wire holder 60 are bent upwards. That is, since the electric wires W become a strain relief structure, even if a pulling force acts on the electric wires W, the pulling force will not act directly on the press contacting points.

In the electric wire holding structure 1 according to the embodiment of the present invention, while the electric wire holder 60 is pivotally supported by the shaft supporting portion 120 and is rotated, the four electric wires W are press contacted to the press contacting terminals 32. Further, the strain relief structure is applied, the pair of electric wire holder holding walls 140 laterally sandwich the parts W1 of the four electric wires W that are bent upwards and the electric wire holder 60, and the electric wire holder 60 is held so that a wobble of the electric wire holder 60 is prevented. Therefore, while the load necessary when the four electric wires W are press contacted to the press contacting terminals 32 is lowered, the connection stability of the electric wires W and the press contacting terminals 32 can be prevented from decreasing.

Further, in the electric wire holding structure 1 according to the embodiment of the present invention, during the rotation of the electric wire holder 60, when the electric wires W contact the pair of electric wire holder holding walls 140 and the electric wire holder 60 is moved upwards due to the reaction force, the surfaces 72b forming the straight line portions 72a of the rotation shafts 72 are abutted with the stepped surfaces 124a, and the electric wire holder 60 is rotated while the stepped surfaces 124a become fulcrums in the principle of leverage. Therefore, even when the electric wire holder 60 is rotated in a state that the four electric wires are located between the pair of electric wire holder holding walls 140, it is possible to reduce the load necessary for the rotation.

In the electric wire holding structure 1 according to the embodiment of the present invention, it is exemplified that the electric wire holder holding walls 140 have a rectangular external shape, but the invention is not limited to this. Other shapes are also possible as long as the electric wire holder holding walls 140 are abutted with the plurality of electric wires W so that the plurality of electric wires W are bent upwards when the electric wire holder 60 is attached while being rotated, and the plurality of electric wires W and the electric wire holder 60 are laterally sandwiched when the electric wire holder 60 has been attached.

In the electric wire holding structure 1 according to the embodiment of the present invention, it is exemplified that the section of the rotation shafts 72 has a semi-circular shape, but the invention is not limited to this and the section may have a circular shape.

The invention accomplished by the inventor is described in detail based on the above embodiment of the invention, but the present invention is not limited to the above embodiment of the invention and can be modified in various ways without departing from the spirit of the invention.

The present application is based on Japanese Patent Application No. 2012-067130, filed on Mar. 23, 2012, the entire contents of which are incorporated herein by reference.

### INDUSTRIAL APPLICABILITY

There is provided an electric wire holding structure capable of lowering a load necessary when a plurality of electric wires are press contacted to press contacting terminals and preventing the connection stability of the electric wires and the press contacting terminals from decreasing.

### REFERENCE SIGNS LIST

1 electric wire holding structure
10 lens
20 lighting function portion
30 busbar
31 power supply terminal
32 press contact terminal
32a press contact blade
32b groove
40 switch operation portion
41 contact
50 bulb
60 electric wire holder
60a holder top surface
60b holder bottom surface
60c side parts
61 through hole for engagement
70 upper holding portion
70a end
70b overlaid surface
71 upper holding side engaging portion
71a convex engaging portion
72 rotation shaft
72a straight line portion
72b surface
73 upper holding side electric wire receiving portion
73a electric wire receiving grooves
80 lower holding portion
80a end
80b overlaid surface
81 lower holding side engaging portion
81a engaging strip
81b engaging hole
82 press contact blade penetrated portion
83 lower holding side electric wire receiving portion
90 joint
100 housing
110 electric wire holder attached portion
110a attached surface
120 shaft supporting portion
121 shaft receiving walls
122 shaft receiving grooves
123 narrow groove portion
124 wide groove portion
124a stepped surface
125 upper protruding wall
125a undersurface
126 engaging wall
130 haft falling preventing and abutting surfaces
140 electric wire holder holding walls
150 engaging portion
151 convex engaging portion
151a elastic engaging strip
152 engaging hole portion
200 lighting device
300 jig for supporting setting electric wires
W electric wires
W1 portion bent upwards

1. A connector connecting structure comprising:
an electric wire holder in which part of a plurality of electric wires are aligned and held and that has a rotation shaft at one end of the electric wire holder in a direction perpendicular to an extending direction of the part of the plurality of electric wires held in the electric wire holder; and
an electric wire holder attached portion that includes a plurality of press contacting terminals to which the plurality of electric wires are press contacted and to which the electric wire holder is attached while the rotation shaft of the electric wire holder is supported by a shaft supporting portion and the electric wire holder is rotated,
wherein the plurality of electric wires are held by being press contacted to the press contacting terminals when the electric wire holder is attached to the electric wire holder attached portion,
the electric wire holder attached portion includes a pair of electric wire holder holding walls which hold the electric wire holder by being abutted with the electric wires so that the electric wires are bent upwards at both side positions of the electric wire holder, and laterally sandwiching parts of the plurality of electric wires that are bent upwards and the electric wire holder when the electric wire holder is attached to the electric wire holder attached portion while the electric wire holder is rotated.

2. The electric wire holding structure according to claim 1, wherein a shape of a cross section of the rotation shaft is a semi-circular shape when the rotation shaft is cut along a plane perpendicular to a rotation axis of the rotation shaft,
the shaft supporting portions have a shaft receiving groove to which the rotation shaft is insertable from above,
the shaft receiving groove includes:
a narrow groove portion whose width is set so that the rotation shaft is insertable in a state where a straight line portion of the semi-circular sections of the rotation shaft faces an edge of the groove; and
a wide groove portion whose width is enlarged with respect to the width of the narrow groove portion so that a stepped face portion are horizontally formed at a lower end of the narrow groove portion and the rotation shaft is rotateable at a bottom of the shaft receiving groove so that the straight line portion face upwards, and
the stepped face portion is abutted with a face forming the straight line portion of the rotation shaft when the electric wire holder is moved upwards during the rotation of the rotation shaft at the bottom of the shaft receiving groove.
